(19) United States
(12) Patent Application Publication
(10) Pub. No.: US 2019/0197395 A1
(43) Pub. Date: Jun. 27, 2019

(54) MODEL ENSEMBLE GENERATION

(71) Applicant: FUJITSU LIMITED, Kawasaki-shi (JP)

(72) Inventors: Masaya KIBUNE, Santa Clara, CA (US); Xuan TAN, Sunnyvale, CA (US)

(73) Assignee: FUJITSU LIMITED, Kawasaki-shi (JP)

(21) Appl. No.: 15/851,723

(22) Filed: Dec. 21, 2017

(51) Int. Cl. G06N 3/08

(52) U.S. Cl. CPC G06N 3/08; G06N 3/084

(57) ABSTRACT

A method of generating a model ensemble may be provided. A method may include training a base model including a plurality of layers. The method may also include generating a plurality of models for the neural network based on the base model. Each model of the plurality of models includes a plurality of layers. Further, the method may include modifying a layer of each of the plurality of models such that each model of the plurality of models includes a layer modified with respect to an associated layer of each of the base model and each of the other plurality of models. In addition, the method may include tuning each modified layer of the plurality of models.

### FIELD

The embodiments discussed herein relate to generating and/or training learning model ensembles.

### BACKGROUND

Neural network analysis may include models of analysis inspired by biological neural networks attempting to model high-level abstractions through multiple processing layers. However, neural network analysis (e.g., generating and/or training model ensembles) may consume large amounts of computing and/or network resources.

The subject matter claimed herein is not limited to embodiments that solve any disadvantages or that operate only in environments such as those described above. Rather, this background is only provided to illustrate one example technology area where some embodiments described herein may be practiced.

### SUMMARY

One or more embodiments of the present disclosure may include a method of generating a model ensemble. The method may include training a base model including a plurality of layers. The method may also include generating a plurality of models of the model ensemble based on the base model, each model of the plurality of models including a plurality of layers. Further, the method may include modifying a layer of each of the plurality of models such that each model of the plurality of models includes a layer modified with respect to an associated layer of each of the base model and an associated layer of each of the other plurality of models. In addition, the method may include tuning each modified layer of the plurality of models.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 depicts an example system including a model ensemble;

FIG. 2 illustrates an example model ensemble including a base model and a plurality of models including modified layers;

FIG. 3 is a flowchart of an example method of generating a model ensemble;

FIG. 4 depicts an example model ensemble including a plurality of convolutional layers and a fully connected layer;

FIG. 5 illustrates a model ensemble and a modifying unit for modifying a layer of a model of the model ensemble; and

FIG. 6 is a block diagram of an example computing device.

### DESCRIPTION OF EMBODIMENTS

Various embodiments disclosed herein relate to ensemble learning. Further, various embodiments relate to generating and/or training neural networks. More specifically, various embodiments relate to generating and/or training deep learning neural network model ensembles.

Ensemble learning may include a process by which a plurality of models (e.g., a model ensemble) may be strategically generated and combined to solve a particular problem (e.g., a computational intelligence problem). Ensemble learning may be used to improve performance (e.g., classification, prediction, function approximation, etc.) of a learning system and/or or reduce the likelihood of a selection of an insufficient model.

Model ensembles may use multiple learning algorithms to enhance accuracy compared to a single learning algorithm. Model ensembles may achieve optimal performance for various machine learning tasks, such as objection detection and object classification. However, to maintain accuracy, known systems and methods may require heavy computation to generate multiple, diverse models.

For example, at least one conventional method includes training independent models with different neural network configurations. In this method, computation time increases linearly as the number of models increases. In another conventional method, models with different classifiers are trained with different neural network configurations. This requires that each model be retrained and, therefore, computation time is undesirably increased. Another conventional method updates one model (e.g., the best model) in a backward pass. However, the forward path computation requirements are unchanged and, thus, this method requires significant computational time and resources. Yet another conventional method includes training models sequentially, and reusing trained parameters between models. However, in this method, training is restricted in a sequential manner, thus limiting use of parallel computation to reduce training time.

According to various embodiments of the present disclosure, a base model may be generated and/or trained. Further, in some embodiments, a plurality of models may be generated based on the base model. Moreover, at least one layer of each model of the plurality of models may be modified. In addition, one or more of the models may be tuned, resulting in ensemble models with high diversity.

According to various embodiments disclosed herein, and in contrast to known deep learning ensemble training systems and methods, a layer is neither deleted nor added to a model ensemble. Thus, compared to known systems and methods, various embodiments of the present disclosure may provide for generation and/or training of deep learning models (e.g., of a model ensemble) with less computational requirements and with comparable accuracy.

Thus, various embodiments of the present disclosure, as described more fully herein, provide a technical solution to a problem that arises from technology that could not reasonably be performed by a person, and various embodiments disclosed herein are rooted in computer technology in order to overcome the problems and/or challenges described above. Further, at least some embodiments disclosed herein may improve computer-related technology by allowing computer performance of a function not previously performable by a computer.

Various embodiments of the present disclosure may be utilized in various applications, such as Internet and Cloud applications (e.g., image classification, speech recognition, language translation, language processing, sentiment analysis recommendation, etc.), medicine and biology (e.g., cancer cell detection, diabetic grading, drug discovery, etc.), media and entertainment (e.g., video captioning, video search, real time translation, etc.), security and defense (e.g., face detection, video surveillance, satellite imagery, etc.), and autonomous machines (e.g., pedestrian detection, lane tracking, traffic signal detection, etc.).

Embodiments of the present disclosure are now explained with reference to the accompanying drawings.

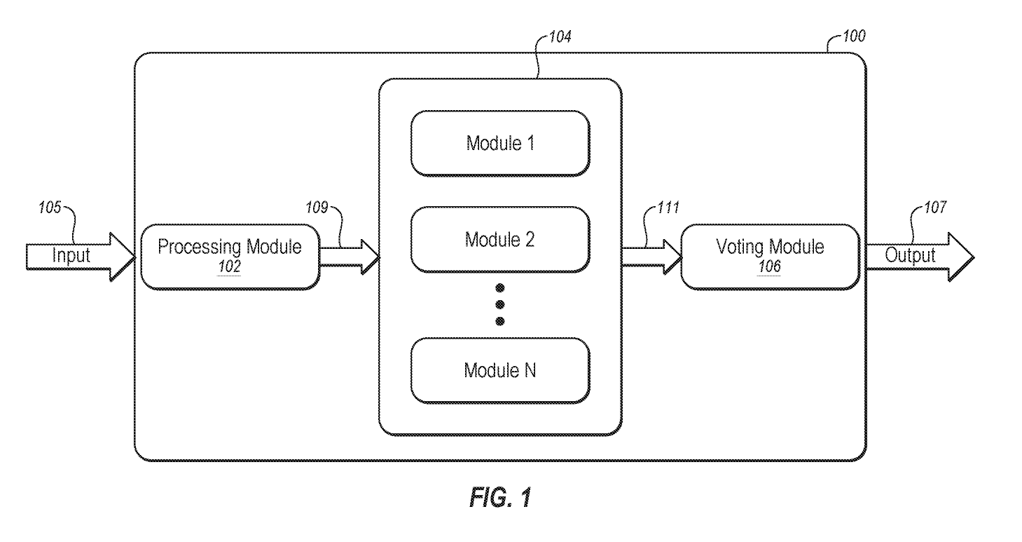

FIG. 1 depicts an example system 100, according to various embodiments of the present disclosure. System 100 includes processing module 102, a model ensemble 104, and a voting module 106. Each model of model ensemble 104 may include a plurality of layers, wherein each layer of each model includes one or more training parameters (e.g., a number on neurons, connections, synaptic weights, bits, etc.), as described more fully herein.

System 100 may be configured to receive an input 105, and generate an output 107, which may include, for example, a prediction output. More specifically, processing module 102 may receive input (e.g., raw data) 107, perform one or more known processing operations on input 107, and convey processed input 109 to each model of model ensemble 104. Further, each model of model ensemble 104 may generate an output 111. Voting module 106 may receive output 111 from each model (e.g., Model_1-Model_N) and may generate output 107 based one or more known voting and/or averaging operations (also referred to herein as “ensemble averaging”). For example, ensemble averaging may include majority voting, weighted voting, weighted averaging, weighted sum, etc.

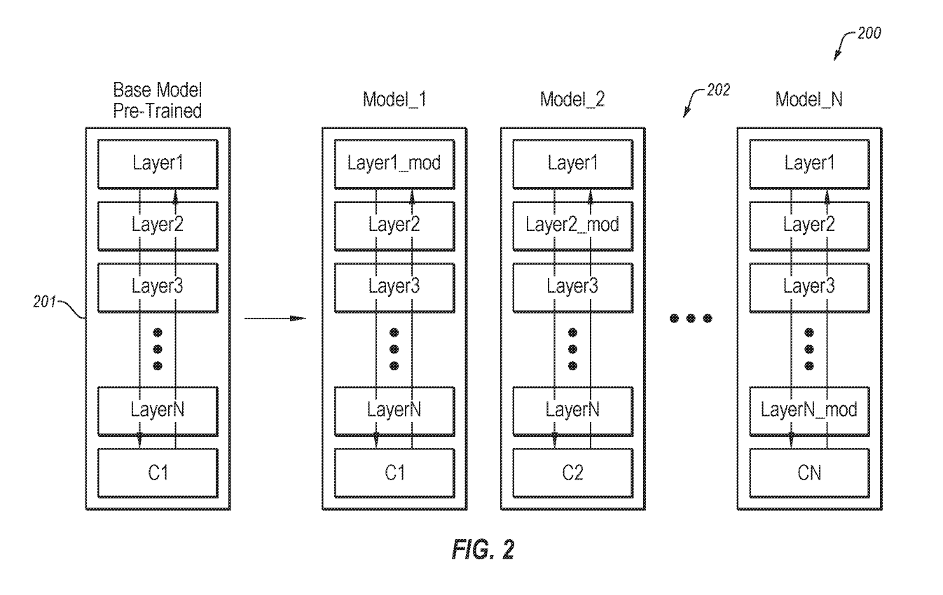

FIG. 2 depicts an example model ensemble (also referred to herein as a neural network including a plurality of models) 200 including a base model 201 and a plurality of models 202 (e.g., Model_1-Model_N). Each model of plurality of models 202 may include a plurality of layers, and each layer of each model may include various training parameters, such as a number of neurons, connections (e.g., connection configurations and/or a number of connections), synaptic weights (e.g., for the connections), a number of bits (e.g., for the synaptic weights), etc.

According to various embodiments, base model 201, which includes a plurality of layers (e.g., Layer1-LayerN and a classification layer C1), may be trained via, for example, conventional backpropagation with random initialization, and/or any other suitable training method. More specifically, one or more training parameters of each layer of base model 200 may be trained.

Further, base model 201 may be used to generate plurality of models 202 via, for example, a clustering method (e.g. k-means), a quantization method (e.g., fixed point, vector, etc.). For example, N copies of base model may be generated, and trained parameters of base model 200 may be used as initial values for each model Model_1-Model_N. Further, according to various embodiments, one or more layers of each model 202 (e.g., Model_1-Model_N) may be modified. More specifically, for example, a first layer (Layer1) of Model_1 may be modified to generate Layed_mod. Further, a second layer (Layer2) of Model_2 may be modified to generate Layer2_mod, and an Nth layer (LayerN) of Model_N may be modified to generate LayerN_mod.

According to various embodiments, to modify a layer, one or more parameters (e.g., training parameters) of the layer may be modified. For example, a number of bits of the layer (e.g., a number of bits for a parameter, such as synaptic weights and/or outputs of neurons) may be modified, a number of neurons of the layer may be modified, a number of connections (e.g., within the layer, to another layer, and/or from another layer) may be modified. For example, a layer may be modified via one or more operations (e.g., clustering, quantization, etc.) performed on one training parameters of the layer.

In some embodiments, modification of a layer may introduce one or more errors in an output of an associated model. Thus, according to at least some embodiments, one or more of models 202 may be tuned (also referred to herein as “fine-tuned”). Tuning the model may reduce, and possibly eliminate, any errors due to modification. For example, each modified layer of model ensemble 200 may be tuned via one or more training operations (e.g., backpropagation) performed on the model.

According to various embodiments, because at least some other layers in model ensemble 200 are already trained (e.g., via training of base model 201), these layers may not require much, if any, further training and/or tuning. Accordingly, compared to fully training a model (e.g., training a base model from scratch), models 202 may require significantly less training.

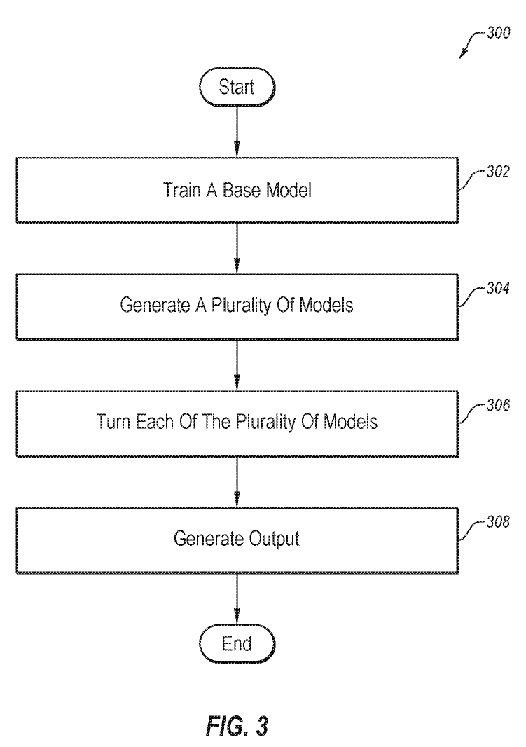

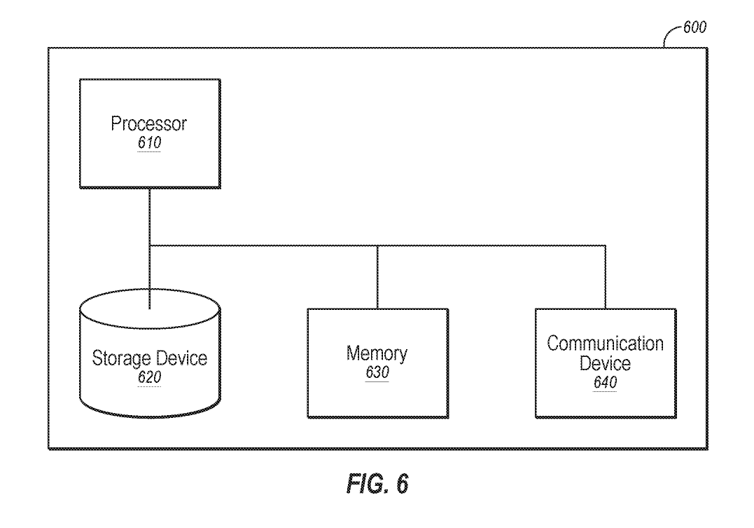

FIG. 3 is a flowchart of an example method 300 of generating a model ensemble, in accordance with at least one embodiment of the present disclosure. Method 300 may be performed by any suitable system, apparatus, or device. For example, system 100 and/or a device 600 of FIG. 6, or one or more of the components thereof may perform one or more of the operations associated with method 300. In these and other embodiments, program instructions stored on a computer readable medium may be executed to perform one or more of the operations of method 300.

At block 302, a base model of a model ensemble may be trained, and method 300 may proceed to block 304. For example, the base model (e.g., base model 201 of FIG. 2) may be trained via conventional backpropagation with random initialization, and/or any other suitable training method. For example, processor 610 of FIG. 6 may be used to train the base model.

At block 304, a plurality of models of the model ensemble may be generated, and method 300 may proceed to block 306. For example, the plurality of models (e.g., models 202) may be generated via the base model (e.g., base model 200 of FIG. 2). More specifically, for example, each of the plurality of models may be generated as a replica of the base model. For example, processor 610 of FIG. 6 may be used to train the base model.

Further, in this example, at least one layer of each model may be modified. According to various embodiments, one or more layers may be modified via one or more operations, such as clustering and/or quantization operations. For example, a number of bits used for one or more parameters of a layer may be modified, a number of neurons of the layer may be modified, a number of connections for the layer (e.g., to and/or from other layers) may be modified, synaptic weights (e.g., of one or more connections) of the layer may be modified. Processor 610 of FIG. 6, for example, may be used to generate and/or modify the at least one layer of each model.

In at least some embodiments, each model of the plurality of models may modified such that at least one layer in each model varies with respect to an associated layer of each of the base model and an associate layer of each of the other plurality of models. More specifically, as an example, a first layer (e.g. Layer1) in a first model (e.g. Model_1) may be modified, a second layer (e.g. Layer2) in a second model (e.g. Model_2) may be modified, a third layer (e.g. Layer3) in a third model (e.g. Model_3) may be modified, and so on (e.g., an Nth layer (e.g., LayerN) in a Nth model (e.g., Model_N) may be modified). In at least this example, other layers in each of the models may or may not be modified. Further, in some embodiments, layers may be selected arbitrarily for modification (e.g., one layer, two layers, three layers, or more, from each model).

At block 306, one or more models of the plurality of models may be tuned, and method 300 may proceed to block 308. For example, each modified layer of the model ensemble may be tuned (e.g., fine-tuned) via one or more known methods (e.g., backpropagation). Further, processor 610 of FIG. 6, for example, may be used to tune the one or more models.

According to various embodiments, other layers (e.g., unmodified layers (e.g., layers that are replicas of associated layers in the based model) in a model may not require much, if any, training or tuning. Thus, additional computation may not be required for the other layers.

At block 308, an output may be generated. For example, based on an output from each model of the model ensemble, which may or may not include a base model, and one or more known voting and/or averaging operations (e.g., ensemble averaging), the output, which may include a prediction, may be generated. For example, in some embodiments, one or more voting and/or averaging operations (e.g., majority voting, weighted voting, weighted averaging, weighted sum, etc.) may be performed to select an output amongst the outputs of each model. For example, processor 610 of FIG. 6 may generate an output (e.g., based on a voting and/or averaging operation).

Modifications, additions, or omissions may be made to method 300 without departing from the scope of the present disclosure. For example, the operations of method 300 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments.

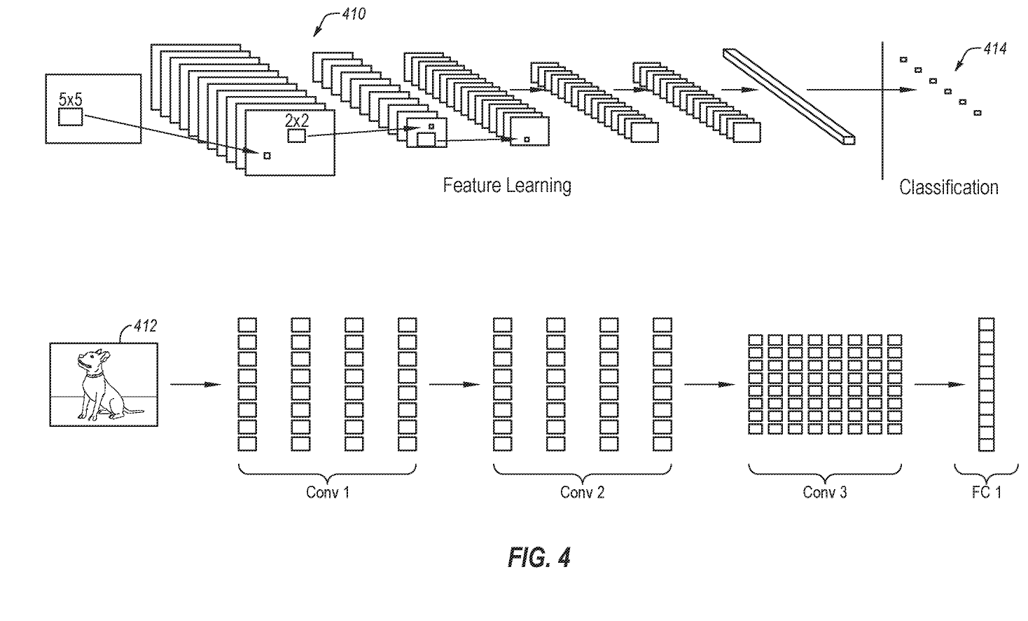

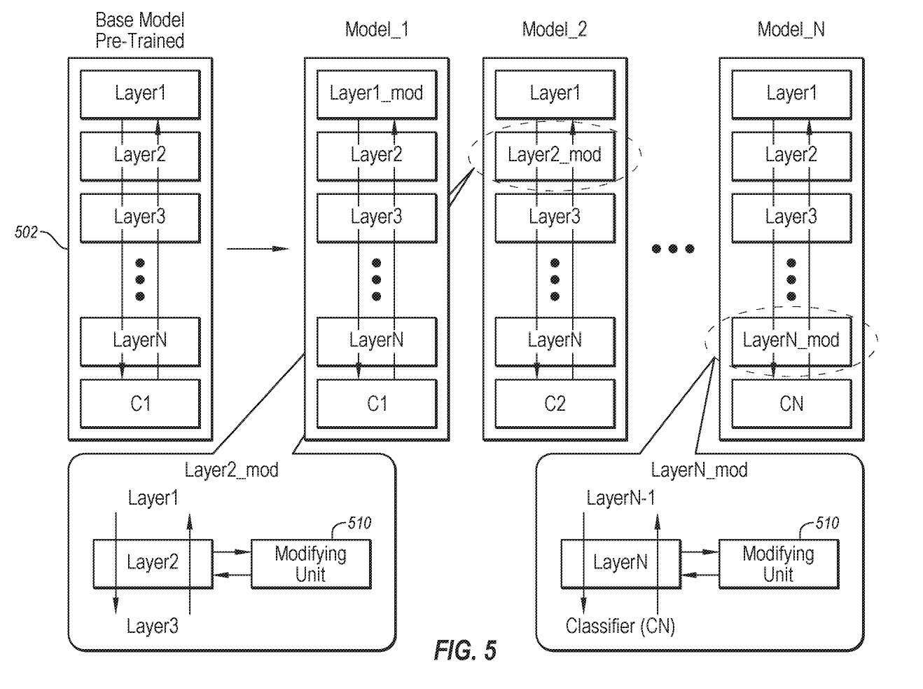

With reference to FIGS. 4 and 5, an example of generating a model ensemble will now be described. Initially, a suitable, properly sized neural network for achieving desired accuracy may be selected. For example, as shown in FIG. 4, a neural network including three convolutional layers Conv1-Conv3 and one fully connected layer FC1 may be selected. The neural network may include various filters 410 to extract features from an input 412 to generate a classification 414.

Further, according to various embodiments of the present disclosure, a base model 502 may be generated and trained. Further, a plurality of models (e.g., Model_1-Model_N) may be generated based on base model 502. In at least some embodiments, initially, each model may be a replica of base model 502. More specifically, each layer (e.g., Layer1-LayerN of each model of the plurality of models (e.g., Model_1-Model_N)) may include parameters that were previously trained (e.g., via base model 502).

Moreover, at least one layer of each model of the plurality of models may be modified. More specifically, for example, a first layer of a first model may be modified, a second layer of a second model may be modified, a third layer of a third model may be modified, and so on (e.g., an Nth layer of an Nth model may be modified). In some embodiments, layers may be modified based on, for example, quantization and/or clustering operations.

For example, with reference to FIG. 5, a Layer1 of Model_1 may be modified, a Layer2 of Model_2 may be modified, and a LayerN of Model_N may be modified. Other layers of each may or may not be modified. With continued reference to FIG. 5, according to one example, a modifying unit 510, which may include, for example, a programmable converter, and/or a clustering unit, may increase or reduce a number of bits for synaptic weights for Layer2 of Model_2. More specifically, for example, Layer2 may be modified by converting a 32 bit floating point synaptic weight of Layer2 to a 16 bit fixed point synaptic weight to generate Layer2_mod. Other parameters of Layer2 of Model_2, such as a number of neurons in Layer2 and/or a number of connections (e.g., to and/or from Layer2) may or may not be modified.

As another example, modifying unit 510 may increase or reduce a number of bits for synaptic weights for LayerN of Model_N. More specifically, for example, LayerN may be modified by converting a 32 bit floating point synaptic weight of LayerN to an index or a value (e.g., a numerical value) to generate LayerN_mod. Other parameters of LayerN of Model_N, such as a number of neurons in LayerN and/or a number of connections (e.g., to and/or from LayerN) may or may not be modified.

Further, each modified model may be tuned. More specifically, each modified layer of each modified model may be tuned. Further, during operation, each model (e.g., with or without utilizing the base model) may generate an output, and one or more voting and/or averaging operations may be performed on the outputs to select an output of a model ensemble.

In one simulation example, a dataset for image recognition with ten classes was used to evaluate the diversity of an ensemble model including four models. In this simulation example, utilizing one or more embodiments of the present disclosure, the time required to generate and train the model ensemble was approximately 820 seconds, and the model ensemble exhibited an accuracy of approximately 24%. In contrast, a conventional method may require approximately 2360 seconds while achieving comparable accuracy (e.g., 23.95%). Further, for example, training each layer of a base model may require approximately 10× epochs (e.g., 100 epochs), wherein tuning a layer (e.g., a modified layer, such as Layer1_mod or Layer2_mod of FIG. 2) may require approximately X epochs (e.g., ten epochs). Thus, in accordance with various embodiments disclosed herein, a model ensemble that includes a base model and four models, may only require approximately 140 epochs. In contrast, some conventional methods may require approximately 400 epochs to generate a model ensemble including four models.

FIG. 6 is a block diagram of an example computing device 600, in accordance with at least one embodiment of the present disclosure. Computing device 600 may include a desktop computer, a laptop computer, a server computer, a tablet computer, a mobile phone, a smartphone, a personal digital assistant (PDA), an e-reader device, a network switch, a network router, a network hub, other networking devices, or other suitable computing device.

Computing device 600 may include a processor 610, a storage device 620, a memory 630, and a communication device 640. Processor 610, storage device 620, memory 630, and/or communication device 640 may all be communicatively coupled such that each of the components may communicate with the other components. Computing device 600 may perform any of the operations described in the present disclosure.

In general, processor 610 may include any suitable special-purpose or general-purpose computer, computing entity, or processing device including various computer hardware or software modules and may be configured to execute instructions stored on any applicable computer-readable storage media. For example, processor 610 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 6, processor 610 may include any number of processors configured to perform, individually or collectively, any number of operations described in the present disclosure.

In some embodiments, processor 610 may interpret and/or execute program instructions and/or process data stored in storage device 620, memory 630, or storage device 620 and memory 630. In some embodiments, processor 610 may fetch program instructions from storage device 620 and load the program instructions in memory 630. After the program instructions are loaded into memory 630, processor 610 may execute the program instructions.

For example, in some embodiments one or more of processing operations for generating and/or training a model ensemble may be included in data storage 620 as program instructions. Processor 610 may fetch the program instructions of one or more of the processing operations and may load the program instructions of the processing operations in memory 630. After the program instructions of the processing operations are loaded into memory 630, processor 610 may execute the program instructions such that computing device 600 may implement the operations associated with the processing operations as directed by the program instructions.

Storage device 620 and memory 630 may include computer-readable storage media for carrying or having computer-executable instructions or data structures stored thereon. Such computer-readable storage media may include any available media that may be accessed by a general-purpose or special-purpose computer, such as processor 610. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 610 to perform a certain operation or group of operations.

In some embodiments, storage device 620 and/or memory 630 may store data associated with generating and/or training neural networks, and more specifically, generating and/or training one or more models in a model ensemble. For example, storage device 620 and/or memory 630 may store model ensemble inputs, model ensemble outputs, model parameters, or any data related to model ensemble generation and/or training.

Communication device 640 may include any device, system, component, or collection of components configured to allow or facilitate communication between computing device 600 and another electronic device. For example, communication device 640 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. Communication device 640 may permit data to be exchanged with any network such as a cellular network, a Wi-Fi network, a MAN, an optical network, etc., to name a few examples, and/or any other devices described in the present disclosure, including remote devices.

Modifications, additions, or omissions may be made to FIG. 6 without departing from the scope of the present disclosure. For example, computing device 600 may include more or fewer elements than those illustrated and described in the present disclosure. For example, computing device 600 may include an integrated display device such as a screen of a tablet or mobile phone or may include an external monitor, a projector, a television, or other suitable display device that may be separate from and communicatively coupled to computing device 600.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of generating a model ensemble, comprising:
training, via at least one processor, a base model including a plurality of layers;
generating, via the at least one processor, a plurality of models for the model ensemble based on the base model, each model of the plurality of models including a plurality of layers;
modifying, via the at least one processor, a layer of each of the plurality of models such that each model of the plurality of models includes a layer modified with respect to an associated layer of each of the base model and an associated layer of each of the other plurality of models; and
tuning, via the at least one processor, each modified layer of the plurality of models.

2. The method of claim 1, further comprising:
receiving an output from each of the plurality of models; and
generating, via the at least one processor, a model ensemble output based on the output of each of the plurality of models.

3. The method of claim 1, wherein modifying comprises modifying the layer of each of the plurality of models based on at least one of clustering and quantization.

4. The method of claim 1, wherein modifying comprises modifying at least one training parameter of the layer of each of the plurality of models.

5. The method of claim 4, wherein modifying at least one training parameter of the layer comprises modifying at least one of a number of bits of the layer, a number of neurons of the layer, weights for one or more connections of the layer, and a number of connections of the layer.

6. The method of claim 1, wherein generating comprises generating, via the at least one processor, each of the plurality of models as a replica of the base model.

7. The method of claim 1, wherein tuning each modified layer comprises tuning each modified layer with an X number of epochs.

8. The method of claim 7, wherein training the base model comprises training the base layer with 10X number of epochs.

9. The method of claim 1, further comprising:
arbitrarily selecting at least one additional layer in at least one model for modification;
modifying the selected at least one additional layer; and
tuning the selected at least one additional layer.

10. The method of claim 1, wherein training the base model comprises training the base model via random initialization.

11. One or more non-transitory computer-readable media that include instructions that, when executed by one or more processors, are configured to cause the one or more processors to perform operations, the operations comprising:
training a base model including a plurality of layers;
generating a plurality of models for a model ensemble based on the base model, each model of the plurality of models including a plurality of layers;
modifying a layer of each of the plurality of models such that each model of the plurality of models includes a layer modified with respect to an associated layer of each of the base model and an associated layer of each of the other plurality of models; and
tuning each modified layer of the plurality of models.

12. The computer-readable media of claim 11, the operations further comprising:
receiving an output from each of the plurality of models; and
generating a model ensemble output based on the output of each of the plurality of models.

13. The computer-readable media of claim 11, wherein modifying comprises modifying the layer of each of the plurality of models based on at least one of clustering and quantization.

14. The computer-readable media of claim 11, wherein modifying comprises modifying at least one training parameter of the layer of each of the plurality of models.

15. The computer-readable media of claim 14, wherein modifying at least one training parameter of the layer comprises modifying at least one of a number of bits of the layer, a number of neurons of the layer, weights for one or more connections of the layer, and a number of connections of the layer.

16. The computer-readable media of claim 11, wherein generating comprises generating, via the at least one processor, each of the plurality of models as a replica of the base model.

17. The computer-readable media of claim 11, wherein tuning each modified layer comprises tuning each modified layer with an X number of epochs.

18. The computer-readable media of claim 17, wherein training the base model comprises training the base layer with 10X number of epochs.

19. The computer-readable media of claim 11, the operations further comprising:
arbitrarily selecting at least one additional layer in at least one model for modification;
modifying the selected at least one additional layer; and
tuning the selected at least one additional layer.

20. The computer-readable media of claim 11, wherein training the base model comprises training the base model via random initialization.
